(19) United States
(12) Patent Application Publication
(10) Pub. No.: US 2024/0221725 A1
(43) Pub. Date: Jul. 4, 2024

(54) SYSTEM AND METHOD FOR ARTIFICIAL INTELLIGENCE-BASED LANGUAGE SKILL ASSESSMENT AND DEVELOPMENT

(71) Applicant: Pearson Education, Inc., Bloomington, MN (US)

(72) Inventors: Mateusz POLTORAK, Poznan (PL); Julia MAY, Poznan (PL); Izabela KRYSINSKA, Poznan (PL); Rafal STACHOWIAK, III, Poznan (PL); Agata HANAS-SZADKOWSKA, Poznan (PL); Michal OKULSKI, Poznan (PL); Marek RYDLEWSKI, Poznan (PL); Jakub ZDANOWSKI, Poznan (PL); Veronica BENIGNO, Dresden (DE); Kacper LODZIKOWSKI, Poznan (PL); Krzysztof JEDRZEJEWSKI, Poznan (PL); Lee BECKER, Boulder, CO (US); Mateusz JEKIEL, Poznan (PL); Emilia MACIEJEWSKA, Poznan (PL); Agnieszka PLUDRA, Poznan (PL)

(21) Appl. No.: 18/399,263

(22) Filed: Dec. 28, 2023

Related U.S. Application Data
(60) Provisional application No. 63/436,201, filed on Dec. 30, 2022.
(60) Provisional application No. 63/449,601, filed on Mar. 2, 2023.
(60) Provisional application No. 63/548,522, filed on Nov. 14, 2023.

(51) Int. Cl. G10L 15/01; G10L 15/16; G10L 15/30

(52) U.S. Cl. CPC G10L 15/01; G10L 15/16; G10L 15/30

(57) ABSTRACT

Systems and methods for dynamic open activity response assessment provide for: receiving an open activity response from a client device of a user; in response to the open activity response, providing the open activity response to multiple machine learning models to process multiple open response assessments in real time; receiving multiple assessment scores from the multiple machine learning models; and providing multiple assessment results to the client device of the user based on the multiple assessment scores corresponding to the multiple open response assessments associated with the open activity response.

### CROSS-REFERENCE TO RELATED APPLICATIONS

This application claims priority to U.S. Provisional Application No. 63/436,201, titled SYSTEM AND METHOD FOR DYNAMIC OPEN ACTIVITY RESPONSE ASSESSMENT, filed on Dec. 30, 2022, to U.S. Provisional Application No. 63/449,601, titled SYSTEM AND METHOD FOR ARTIFICIAL INTELLIGENCE-BASED LANGUAGE SKILL ASSESSMENT AND DEVELOPMENT, filed on Mar. 2, 2023, and to U.S. Provisional Application No. 63/548,522, titled SYSTEM AND METHOD FOR ARTIFICIAL INTELLIGENCE-BASED LANGUAGE SKILL ASSESSMENT AND DEVELOPMENT, filed on Nov. 14, 2023, the entirety of each of which is incorporated herein by reference.

### TECHNICAL FIELD

This disclosure relates to the field of systems and methods configured to assess and develop language skills to maximize learning potential.

### SUMMARY

The disclosed technology relates to systems and methods including one or more server hardware computing devices or client hardware computing devices, communicatively coupled to a network, and each including at least one processor executing specific computer-executable instructions within a memory that, when executed, cause the system to: receive an open activity response from a client device of a user and provide the open activity response to a plurality of machine learning models to process a plurality of open response assessments in real time in response to the open activity response. The plurality of machine learning models corresponds to the plurality of open response assessments. A first open response assessment of the plurality of open response assessments is agnostic with respect to a second open response assessment of the plurality of open response assessments. The system is further caused to receive a plurality of assessment scores from the plurality of machine learning models and provide a plurality of assessment results to the client device of the user based on the plurality of assessment scores corresponding to the plurality of open response assessments associated with the open activity response. The plurality of assessment scores corresponds to the plurality of open response assessments.

The above features and advantages of the present invention will be better understood from the following detailed description taken in conjunction with the accompanying drawings.

### BRIEF DESCRIPTION OF THE DRAWINGS

FIG. 1 illustrates a system level block diagram for providing the disclosed plugin system and pathway architecture.

FIG. 2 illustrates a system level block diagram for providing the disclosed plugin system and pathway architecture, in accordance with various aspects of the techniques described in this disclosure.

FIG. 3 illustrates a system level block diagram of a content management system that facilitates the disclosed plugin system and pathway architecture, in accordance with various aspects of the techniques described in this disclosure.

FIG. 4 is a flowchart illustrating an example method and technique for a real-time open activity response assessment system, in accordance with various aspects of the techniques described in this disclosure.

FIG. 5 is a block diagram for providing the components and pathway architecture in a real-time open activity response assessment system, in accordance with various aspects of the techniques described in this disclosure.

FIG. 6 is a block diagram for providing the pathway architecture of an open response assessment component in a real-time open activity response assessment system, in accordance with various aspects of the techniques described in this disclosure.

FIG. 7 is a block diagram for providing the pathway architecture of an open response assessment component in a real-time open activity response assessment system, in accordance with various aspects of the techniques described in this disclosure.

FIG. 8 is a block diagram for providing the pathway architecture of a pronunciation assessment component in a real-time open activity response assessment system, in accordance with various aspects of the techniques described in this disclosure.

FIG. 9 is a block diagram for providing the pathway architecture of a learner model component in a real-time open activity response assessment system, in accordance with various aspects of the techniques described in this disclosure.

FIG. 10 is a block diagram for providing the pathway architecture of a learner model component, a personalization component, and a domain model component in a real-time open activity response assessment system, in accordance with various aspects of the techniques described in this disclosure.

FIG. 11 is a block diagram for providing the pathway architecture of a learner model component and a personalization component in a real-time open activity response assessment system, in accordance with various aspects of the techniques described in this disclosure.

FIG. 12 is a block diagram for providing the pathway architecture of an assessment component, a learner model component, and personalization component in a real-time open activity response assessment system, in accordance with various aspects of the techniques described in this disclosure.

FIG. 13 is a flowchart illustrating another example method and technique for a real-time open activity response assessment system, in accordance with various aspects of the techniques described in this disclosure.

FIG. 14 is a block diagram for showing interactions between a client device and a server and processes in the client device and/or the server in accordance with various aspects of the techniques described in this disclosure.

FIG. 15 is a block diagram for showing response evaluation component in accordance with various aspects of the techniques described in this disclosure.

FIG. 16 is a block diagram for showing assessment metrics of multiple open response assessments. in accordance with various aspects of the techniques described in this disclosure.

FIG. 17A is a schematic diagram conceptually illustrating an example screen of a GUI for assessing speaking and reading of a learner, and FIG. 17B is a schematic diagram conceptually illustrating an example screen of a GUI for providing assessment results of the speaking and the reading of the learner, in accordance with various aspects of the techniques described in this disclosure.

FIG. 18A is a schematic diagram conceptually illustrating an example screen of a GUI for assessing writing and listening of a learner, and FIG. 18B is a schematic diagram conceptually illustrating an example screen of a GUI for providing assessment results of the writing and listening of the learner, in accordance with various aspects of the techniques described in this disclosure.

FIG. 19A is a schematic diagram conceptually illustrating an example screen of a GUI for assessing speaking and listening of a learner, and FIG. 19B is a schematic diagram conceptually illustrating an example screen of a GUI for providing assessment results of the speaking and listening of the learner, in accordance with various aspects of the techniques described in this disclosure.

### DETAILED DESCRIPTION

The disclosed technology will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

In online learning environments in which a user (e.g., a learner user, etc.) is presented with learning information or discusses the learning information, the assessment or feedback about the user's proficiency (e.g., language) during the learning, discussion, or conversation with an instructor or an agent may be limited. In such examples, the user may receive the feedback or assessment results a few hours or days after the learning. Thus, the user may be unable to accurately remember the content or specific wording that the user used when the user receives the feedback or assessment results. Furthermore, systems may only assess the learner's proficiency during predetermined tests. Thus, systems are unable to effectively capture the user learner' proficiency due to the unnatural testing environment and limited amount of data to assess.

In addition, speaking practice and access to a personal tutor have been the least addressed needs of language learners. Previous solutions provided only very basic speaking practice that was constrained and mostly involved recording words or sentences of pronunciation. Similarly, access to private language tutors was no affordable to most learners. Private language tutors are also subjective in providing feedback and are only available at a limited time based on the private language tutors' schedules. Further, it is hard to find target language users to practice speaking. Thus, current systems are unable to objectively provide feedback to language learners and unable to provide an environment for language learners to practice speaking.

The disclosed system includes, among other things, a real-time open activity response assessment system that is able to assess written and/or spoken responses during the conversations, discussions, or learning environments in real time. In some examples, open response assessments are processed in real-time or near real-time in that the open response assessments are processed and produce the results within a limited time period (e.g., 1, 5, 10, 20, or 30 seconds) in response to receiving an open activity response or a user input (e.g., one or more spoken or written sentences) from a client device of the user. Therefore, the user does not need to wait for assessment results or feedback a few hours or days after the learning. In addition, the disclosed system uses multiple machine learning models to process multiple open response assessments for an open activity response. Thus, the disclosed system can provide multiple assessment results for one open activity response at the same time. Further, the multiple machine learning models that process multiple open response assessments produce consistent and objective assessment results without any time constraint. Additionally, by providing dedicated machine learning models dedicated to particular types of assessments (e.g., grammar, vocabulary, content), the system may be easily updated to select and use one or more newly available machine learning models in place of previously used machine learning models. Additionally, the system may select and use one or more machine learning models with desirable characteristics for a particular scenario. Accordingly, for a particular open activity response, the system may select a particular set of machine learning models with desirable characteristics. For example, in some scenarios, the system may select one or more machine learning models specific to the system platform (e.g., developed, trained, and/or maintained by the entity or institution managing the assessments) and one or more machine learning models developed, trained, maintained, and/or hosted by a third party independent of the system platform. Thus, the particular combination of machine learning models used to assess an open activity response may be selected and may evolve over time to address changing needs and capabilities of the system and available assessment models.

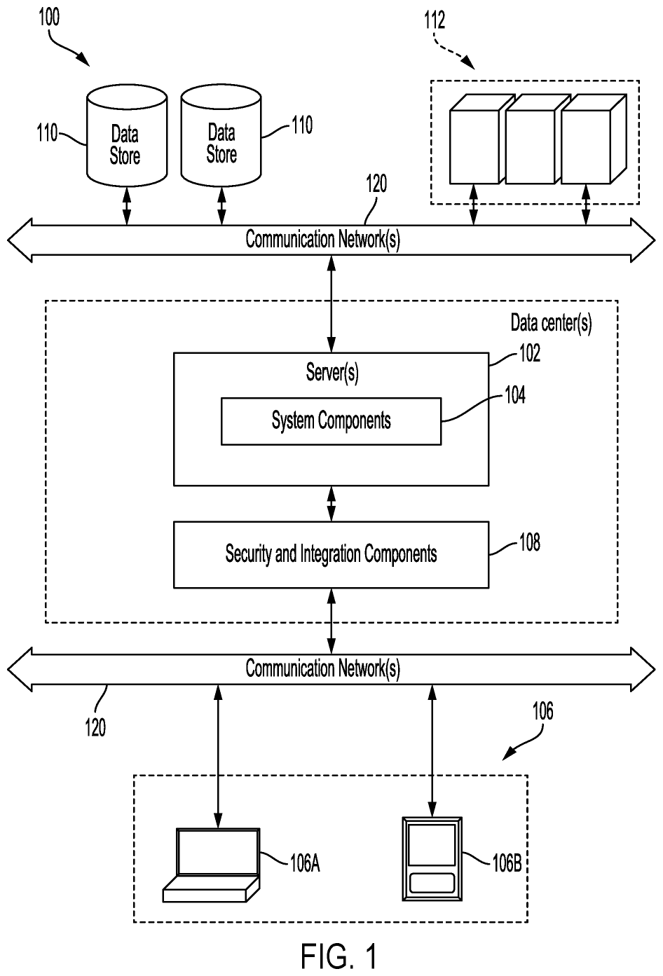

FIG. 1 illustrates a non-limiting example of a distributed computing environment 100. In some examples, the distributed computing environment 100 may include one or more server(s) 102 (e.g., data servers, computing devices, computers, etc.), one or more client computing devices 106, and other components that may implement certain embodiments and features described herein. Other devices, such as specialized sensor devices, etc., may interact with the client computing device(s) 106 and/or the server(s) 102. The server(s) 102, client computing device(s) 106, or any other devices may be configured to implement a client-server model or any other distributed computing architecture. In an illustrative and non-limiting example, the client devices 106 may include a first client device 106A and a second client device 106B. The first client device 106A may correspond to a first user in a class and the second client device 106B may correspond to a second user in the class or another class.

In some examples, the server(s) 102, the client computing device(s) 106, and any other disclosed devices may be communicatively coupled via one or more communication network(s) 120. The communication network(s) 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as, e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

The embodiments shown in FIGS. 1 and/or 2 are one example of a distributed computing system and are not intended to be limiting. The subsystems and components within the server(s) 102 and the client computing device(s) 106 may be implemented in hardware, firmware, software, or combinations thereof. Various different subsystems and/or components 104 may be implemented on server 102. Users operating the client computing device(s) 106 may initiate one or more client applications to use services provided by these subsystems and components. Various different system configurations are possible in different distributed computing environments 100 and content distribution networks. Server 102 may be configured to run one or more server software applications or services, for example, web-based or cloud-based services, to support content distribution and interaction with client computing device(s) 106. Users operating client computing device(s) 106 may in turn utilize one or more client applications (e.g., virtual client applications) to interact with server 102 to utilize the services provided by these components. The client computing device(s) 106 may be configured to receive and execute client applications over the communication network(s) 120. Such client applications may be web browser-based applications and/or standalone software applications, such as mobile device applications. The client computing device(s) 106 may receive client applications from server 102 or from other application providers (e.g., public or private application stores).

As shown in FIG. 1, various security and integration components 108 may be used to manage communications over the communication network(s) 120 (e.g., a file-based integration scheme, a service-based integration scheme, etc.). In some examples, the security and integration components 108 may implement various security features for data transmission and storage, such as authenticating users or restricting access to unknown or unauthorized users. As non-limiting examples, the security and integration components 108 may include dedicated hardware, specialized networking components, and/or software (e.g., web servers, authentication servers, firewalls, routers, gateways, load balancers, etc.) within one or more data centers in one or more physical location(s) and/or operated by one or more entities, and/or may be operated within a cloud infrastructure. In various implementations, the security and integration components 108 may transmit data between the various devices in the distribution computing environment 100 (e.g., in a content distribution system or network). In some examples, the security and integration components 108 may use secure data transmission protocols and/or encryption (e.g., File Transfer Protocol (FTP), Secure File Transfer Protocol (SFTP), and/or Pretty Good Privacy (PGP) encryption) for data transfers, etc.).

In some examples, the security and integration components 108 may implement one or more web services (e.g., cross-domain and/or cross-platform web services) within the distribution computing environment 100, and may be developed for enterprise use in accordance with various web service standards (e.g., the Web Service Interoperability (WS-I) guidelines). In an example, some web services may provide secure connections, authentication, and/or confidentiality throughout the network using technologies such as SSL, TLS, HTTP, HTTPS, WS-Security standard (providing secure SOAP messages using XML encryption), etc. In some examples, the security and integration components 108 may include specialized hardware, network appliances, and the like (e.g., hardware-accelerated SSL and HTTPS), possibly installed and configured between one or more server(s) 102 and other network components. In such examples, the security and integration components 108 may thus provide secure web services, thereby allowing any external devices to communicate directly with the specialized hardware, network appliances, etc.

A distribution computing environment 100 may further include one or more data stores 110. In some examples, the one or more data stores 110 may include, and/or reside on, one or more back-end servers 112, operating in one or more data center(s) in one or more physical locations. In such examples, the one or more data stores 110 may communicate data between one or more devices, such as those connected via the one or more communication network(s) 120. In some cases, the one or more data stores 110 may reside on a non-transitory storage medium within one or more server(s) 102. In some examples, data stores 110 and back-end servers 112 may reside in a storage-area network (SAN). In addition, access to one or more data stores 110, in some examples, may be limited and/or denied based on the processes, user credentials, and/or devices attempting to interact with the one or more data stores 110.

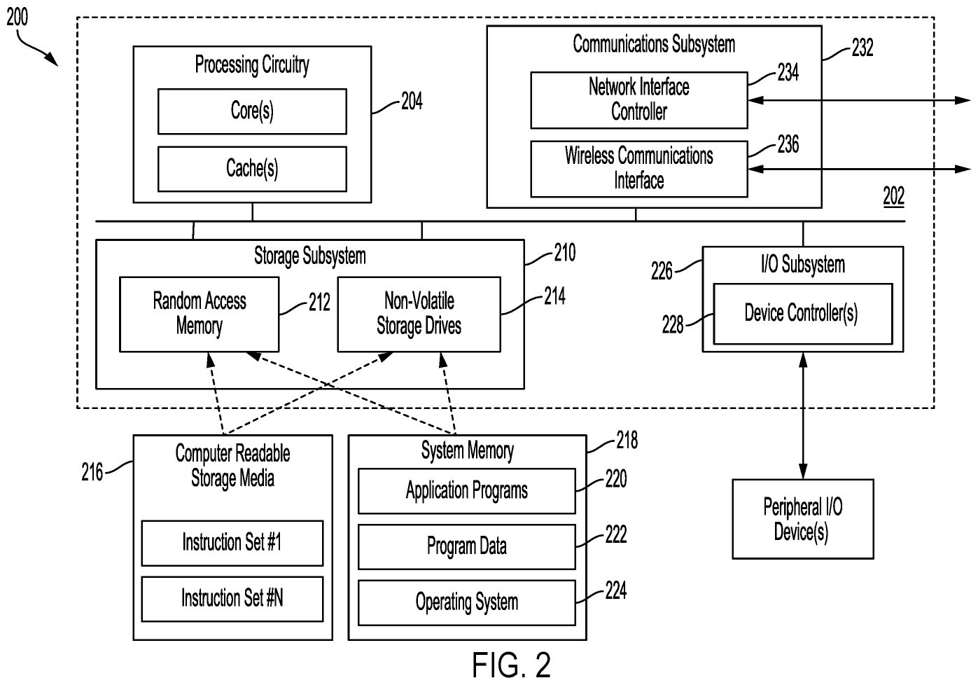

With reference now to FIG. 2, a block diagram of an example computing system 200 is shown. The computing system 200 (e.g., one or more computers) may correspond to any one or more of the computing devices or servers of the distribution computing environment 100, or any other computing devices described herein. In an example, the computing system 200 may represent an example of one or more server(s) 102 and/or of one or more server(s) 112 of the distribution computing environment 100. In another example, the computing system 200 may represent an example of the client computing device(s) 106 of the distribution computing environment 100. In some examples, the computing system 200 may represent a combination of one or more computing devices and/or servers of the distribution computing environment 100.

In some examples, the computing system 200 may include processing circuitry 204, such as one or more processing unit(s), processor(s), etc. In some examples, the processing circuitry 204 may communicate (e.g., interface) with a number of peripheral subsystems via a bus subsystem 202. These peripheral subsystems may include, for example, a storage subsystem 210, an input/output (I/O) subsystem 226, and a communications subsystem 232.

In some examples, the processing circuitry 204 may be implemented as one or more integrated circuits (e.g., a conventional micro-processor or microcontroller). In an example, the processing circuitry 204 may control the operation of the computing system 200. The processing circuitry 204 may include single core and/or multicore (e.g., quad core, hexa-core, octo-core, ten-core, etc.) processors and processor caches. The processing circuitry 204 may execute a variety of resident software processes embodied in program code, and may maintain multiple concurrently executing programs or processes. In some examples, the processing circuitry 204 may include one or more specialized processors, (e.g., digital signal processors (DSPs), outboard, graphics application-specific, and/or other processors).

In some examples, the bus subsystem 202 provides a mechanism for intended communication between the various components and subsystems of computing system 200. Although the bus subsystem 202 is shown schematically as a single bus, alternative embodiments of the bus subsystem may utilize multiple buses. In some examples, the bus subsystem 202 may include a memory bus, memory controller, peripheral bus, and/or local bus using any of a variety of bus architectures (e.g., Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

In some examples, the I/O subsystem 226 may include one or more device controller(s) 228 for one or more user interface input devices and/or user interface output devices, possibly integrated with the computing system 200 (e.g., integrated audio/video systems, and/or touchscreen displays), or may be separate peripheral devices which are attachable/detachable from the computing system 200. Input may include keyboard or mouse input, audio input (e.g., spoken commands), motion sensing, gesture recognition (e.g., eye gestures), etc. As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like. In general, use of the term “output device” is intended to include all possible types of devices and mechanisms for outputting information from computing system 200, such as to a user (e.g., via a display device) or any other computing system, such as a second computing system 200. In an example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or may include one or more non-visual display subsystems and/or non-visual display devices, such as audio output devices, etc. As non-limiting examples, output devices may include, indicator lights, monitors, printers, speakers, headphones, automotive navigation systems, plotters, voice output devices, modems, etc.

In some examples, the computing system 200 may include one or more storage subsystems 210, including hardware and software components used for storing data and program instructions, such as system memory 218 and computer-readable storage media 216. In some examples, the system memory 218 and/or the computer-readable storage media 216 may store and/or include program instructions that are loadable and executable on the processor(s) 204. In an example, the system memory 218 may load and/or execute an operating system 224, program data 222, server applications, application program(s) 220 (e.g., client applications), Internet browsers, mid-tier applications, etc. In some examples, the system memory 218 may further store data generated during execution of these instructions.

In some examples, the system memory 218 may be stored in volatile memory (e.g., random-access memory (RAM) 212, including static random-access memory (SRAM) or dynamic random-access memory (DRAM)). In an example, the RAM 212 may contain data and/or program modules that are immediately accessible to and/or operated and executed by the processing circuitry 204. In some examples, the system memory 218 may also be stored in non-volatile storage drives 214 (e.g., read-only memory (ROM), flash memory, etc.). In an example, a basic input/output system (BIOS), containing the basic routines that help to transfer information between elements within the computing system 200 (e.g., during start-up), may typically be stored in the non-volatile storage drives 214.

In some examples, the storage subsystem 210 may include one or more tangible computer-readable storage media 216 for storing the basic programming and data constructs that provide the functionality of some embodiments. In an example, the storage subsystem 210 may include software, programs, code modules, instructions, etc., that may be executed by the processing circuitry 204, in order to provide the functionality described herein. In some examples, data generated from the executed software, programs, code, modules, or instructions may be stored within a data storage repository within the storage subsystem 210. In some examples, the storage subsystem 210 may also include a computer-readable storage media reader connected to the computer-readable storage media 216.

In some examples, the computer-readable storage media 216 may contain program code, or portions of program code. Together and, optionally, in combination with the system memory 218, the computer-readable storage media 216 may comprehensively represent remote, local, fixed, and/or removable storage devices plus storage media for temporarily and/or more permanently containing, storing, transmitting, and/or retrieving computer-readable information. In some examples, the computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer-readable media. This can also include nontangible computer-readable media, such as data signals, data transmissions, or any other medium which can be used to transmit the desired information and which can be accessed by the computing system 200. In an illustrative and non-limiting example, the computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media.

In some examples, the computer-readable storage media 216 may include, but is not limited to, Zip® drives, flash memory cards, universal serial bus (USB) flash drives, secure digital (SD) cards, DVD disks, digital video tape, and the like. In some examples, the computer-readable storage media 216 may include, solid-state drives (SSD) based on non-volatile memory such as flash-memory based SSDs, enterprise flash drives, solid state ROM, and the like, SSDs based on volatile memory such as solid-state RAM, dynamic RAM, static RAM, DRAM-based SSDs, magneto-resistive RAM (MRAM) SSDs, and hybrid SSDs that use a combination of DRAM and flash memory-based SSDs. The disk drives and their associated computer-readable media may provide non-volatile storage of computer-readable instructions, data structures, program modules, and other data for the computing system 200.

In some examples, the communications subsystem 232 may provide a communication interface from the computing system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally, and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 232 also may include radio frequency (RF) transceiver components for accessing wireless voice and/or data networks (e.g., using cellular telephone technology, advanced data network technology, such as 3G, 4G, 5G or EDGE (enhanced data rates for global evolution), Wi-Fi (IEEE 802.11 family standards, or other mobile communication technologies, or any combination thereof), global positioning system (GPS) receiver components, and/or other components.

In some examples, the communications subsystem 232 may also receive input communication in the form of structured and/or unstructured data feeds, event streams, event updates, and the like, on behalf of one or more users who may use or access the computing system 200. In an example, the communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, the communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). In some examples, the communications subsystem 232 may output such structured and/or unstructured data feeds, event streams, event updates, and the like to one or more data stores that may be in communication with one or more streaming data source computing systems (e.g., one or more data source computers, etc.) coupled to the computing system 200. The various physical components of the communications subsystem 232 may be detachable components coupled to the computing system 200 via a computer network (e.g., a communication network 120), a FireWire® bus, or the like, and/or may be physically integrated onto a motherboard of the computing system 200. In some examples, the communications subsystem 232 may be implemented in whole or in part by software.

Due to the ever-changing nature of computers and networks, the description of the computing system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

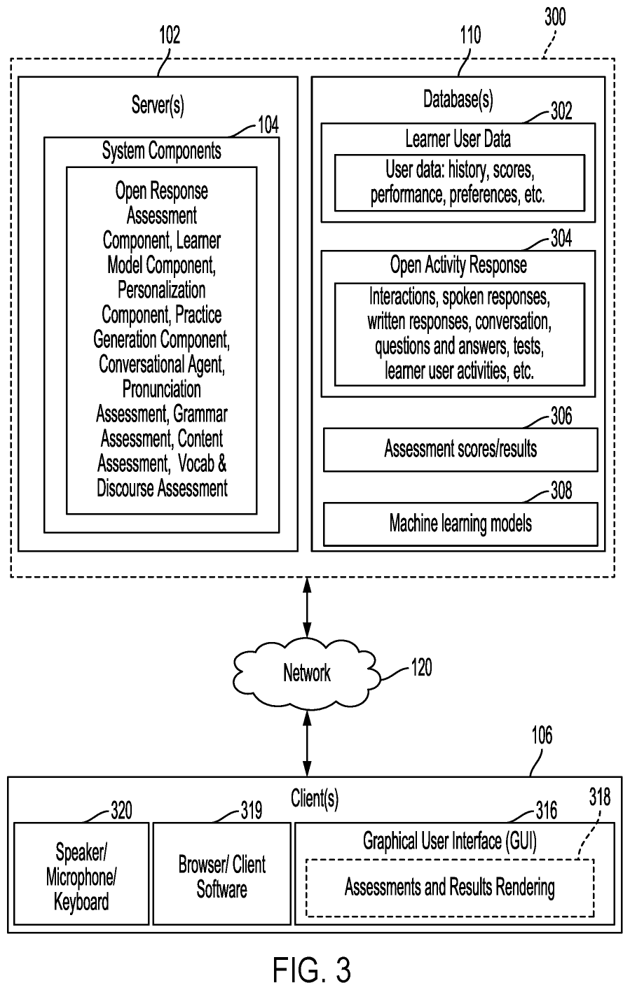

FIG. 3 illustrates a system level block diagram of a language assessment and development system 300, such as a user assessment system for providing the disclosed assessment results according to some examples. In some examples, the language assessment and development system 300 may include one or more database(s) 110, also referred to as data stores herein. The database(s) 110 may include a plurality of user data 302 (e.g., a set of user data items). In such examples, the language assessment and development system 300 may store and/or manage the user data 302 in accordance with one or more of the various techniques of the disclosure. In some examples, the user data 302 may include user responses, user history, user scores, user performance, user preferences, and the like.

In some examples, the language assessment and development system 300 may utilize the user data to determine the level of assessments, and in some examples, the language assessment and development system 300 may customize the level of assessments and/or conversation for a particular user (e.g., a learner user). In some examples, the language assessment and development system 300 may collect and aggregate some or all proficiency estimates and evidence points from various sources (e.g., platforms, open response assessment component, a personalization component, a pronunciation assessment, a practice generation component, etc.) to determine the level of assessments. The level of assessments can be stored in the database 110. In further examples, the level of assessments may be received by other sources (e.g., third-party components).

In addition, the database(s) 110 may include open activity response(s) 304. In some examples, the open activity response 304 may include multiple interactions of a user, and an interaction may include a spoken response or a written response. In some examples, the open activity response(s) is generated during a conversation, questions and answers, tests, and other various user activities.

In addition, the database(s) 110 may further include assessment result(s) 306. For example, the language assessment and development system 300 can produce assessment result(s) 306 using multiple assessments for open activity response(s) 306 and store the assessment result(s) 306 in the database 110.

In addition, the database(s) 110 may further include multiple machine learning models 308 to process multiple open response assessments. In some examples, trained machine learning models 308 can be stored in the database 110. In other examples, machine learning models 308 can be trained in the language assessment and development system 300. In further examples, the trained machine learning models 308 are stored in the database 110 and can be further trained based on the open activity response 304 and/or assessment score/results 306. In some examples, the machine learning models 308 can be trained in the language assessment and development system 300 or in any other suitable other system.

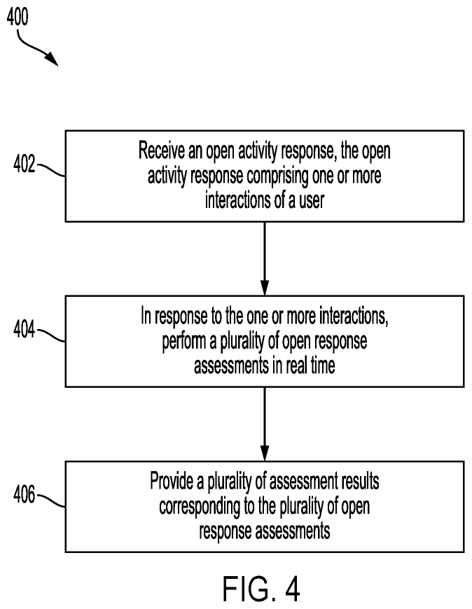

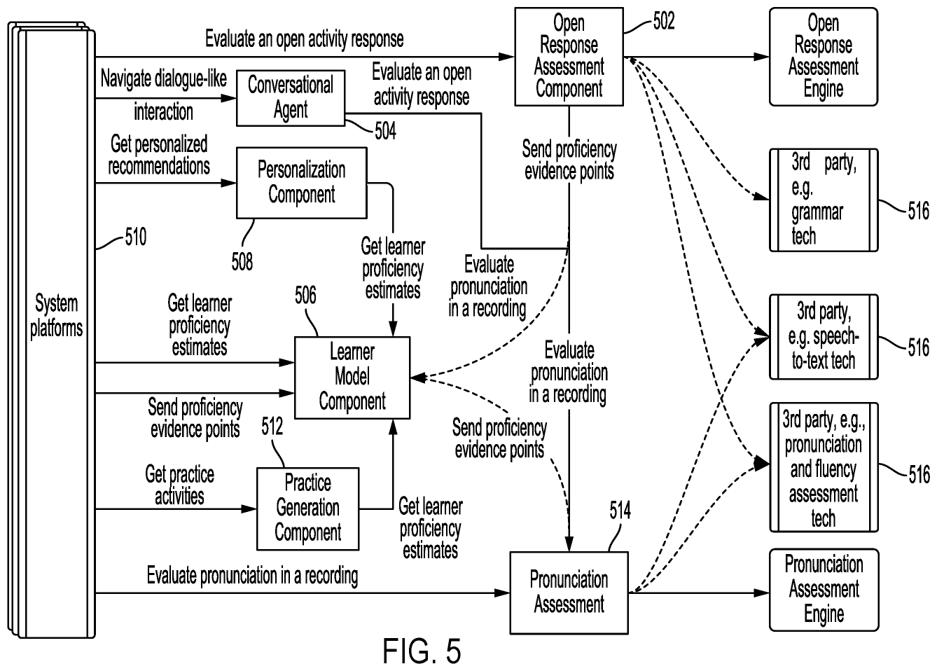

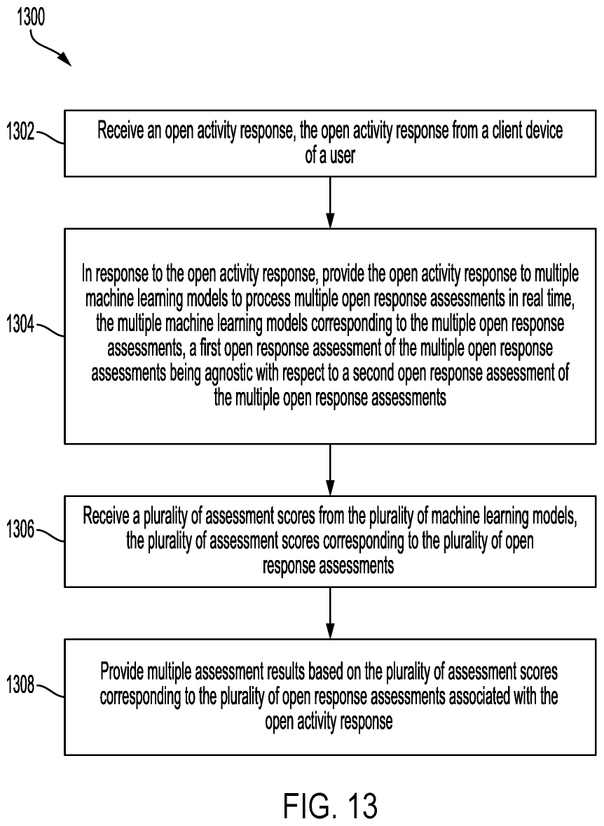

In some aspects of the disclosure, the server 102 in coordination with the database(s) 110 may configure the system components 104 (e.g., Open Response Assessment Component, Learner Model Component, Personalization Component, Practice Generation Component, Conversational Agent, Pronunciation Assessment, Grammar Assessment, Content Assessment, Vocab & Discourse Assessment, etc.) for various functions, including, e.g., receiving an open activity response; in response to the plurality of interactions, performing a plurality of open response assessments in real time; providing a plurality of assessment results corresponding to the plurality of open response assessments; and/or adjusting a conversation difficulty level of the conversation based on the plurality of assessment results. For example, the system components 104 may be configured to implement one or more of the functions described below in relation to FIG. 4, including, e.g., blocks 402, 404, and/or 406, and/or may be configured to implement one or more functions described below in relation to FIG. 13, including blocks 1302, 1304, 1306, and/or 1308. Examples of the system components 104 of the server 102 are also described in further detail below with respect to the diagrams of FIGS. 5-12 and 14-19B. The system components 104 may, in some examples, be implemented by an electronic processor of the server 102 (e.g., processing circuitry 204 of FIG. 2) executing instructions stored and retrieved from a memory of the server 102 (e.g., storage subsystem 210, computer readable storage media 216, and/or system memory 218 of FIG. 2).

In some examples, the real-time open activity response assessment system 300 may interact with the client computing device(s) 106 via one or more communication network(s) 120. In some examples, the client computing device(s) 106 can include a graphical user interface (GUI) 316 to display assessments 318 (e.g., conversation, questions and answers, tests, etc.). and assessment results for the user. In some examples, the GUI 316 may be generated in part by execution by the client 106 of browser/client software 319 and based on data received from the system 300 via the network 120. In some examples, the client device(s) 106 include a user interface (UI) 320 including a speaker, a microphone, and a keyboard to receive a spoken sentence/response and a written sentence/response and produce audio to the user.

FIG. 4 is a flowchart illustrating an example method and technique for a real-time open activity response assessment system, in accordance with various aspects of the techniques described in this disclosure. The flowchart of FIG. 4 utilizes various system components that are described below with reference to FIGS. 5-9. In some examples, the process 400 may be carried out by the server(s) 102 illustrated in FIG. 3, e.g., employing circuitry and/or software configured according to the block diagram illustrated in FIG. 2. In some examples, the process 400 may be carried out by any suitable apparatus or means for carrying out the functions or algorithm described below. Additionally, although the blocks of the flowchart 400 are presented in a sequential manner, in some examples, one or more of the blocks may be performed in a different order than presented, in parallel with another block, or bypassed.

At block 402, a server (e.g., one or more of the server(s) 102, also referred to as the server 102) receives an open activity response from a user (e.g., a client device 106). Referring to FIG. 5, an open response assessment component 502 receives the open activity response from the user. In some examples, the open activity response includes one or more interactions of the user. In further examples, the one or more interactions are produced during a conversation between an agent 504 and the user. In some examples, the open activity response including the one or more interactions can be considered “open” because it includes time-series data without a fixed time period or any fixed format. In some examples, the open activity response can be considered “open” because it may be received from various sources (e.g., system platforms, third-party platforms) and is not limited to a closed set of sources of the system operator. In some examples, an interaction can include a written response or a spoken response. For example, the agent 504 and the user can have a casual conversation or a conversation with a specific topic. During the conversation, the agent 504 can provide questions relevant to the topic, and the user can provide written or spoken responses to the questions. In some examples, the agent 504 can specifically request that the user provide a response in a written or spoken response for a certain question. In further examples, the agent 504 can request that the user rephrase or paraphrase the previous response. In further examples, the agent 504 can navigate dialogue-like interactions with the user in the database 110. In some scenarios, the agent 504 includes a conversational computing agent (e.g., a chatbot) as shown in FIG. 5 including a program designed to perform the conversation with the user. In other scenarios, the agent 504 executes software (e.g., speech-to-text conversion software or typed text capturing software) to capture a conversation between a human agent and the user. In some scenarios, the server 102 receives open activity responses from other suitable sources (e.g., other platforms, third party database, etc.).

In some examples, the server 102 can select a topic of the conversation for the agent 504 based on indications of the user. For example, the indications can be included in a profile and/or behavioral data of the user or can be provided by the user. In some scenarios, the server 102 can select a topic for the conversation based on the user's career, interesting subjects, or any other suitable personal information for the user, which is stored in the user data 302. In further examples, the server 102 can select a proficiency level for the conversation based on proficiency estimates of the user. In some examples, a learner model component 506 can collect and aggregate all proficiency estimates and evidence points in all areas (e.g., “past simple questions,” “pronunciation of the word ‘queue,’” “participation in a business meeting,” user profile, behavioral data, etc.). In further examples, the learner model component 506 can collect proficiency estimates and evidence points from the open response assessment component 502, a personalization component 508, system platforms 510, a practice generation component 512, a pronunciation assessment 514. It should be appreciated that the proficiency estimates and evidence points can be collected from any other suitable sources (e.g., third party database) and can be aggregated to produce aggregated proficiency indications. In further examples, the server 102 can select the conversation based on the aggregated proficiency indications of the user from the learner model component 506. In even further examples, the server 102 can select a proficiency level for each categorized area (e.g., subject, topic, grammar, vocabulary, pronunciation, etc.) of the conversation between the agent 504 and the user.

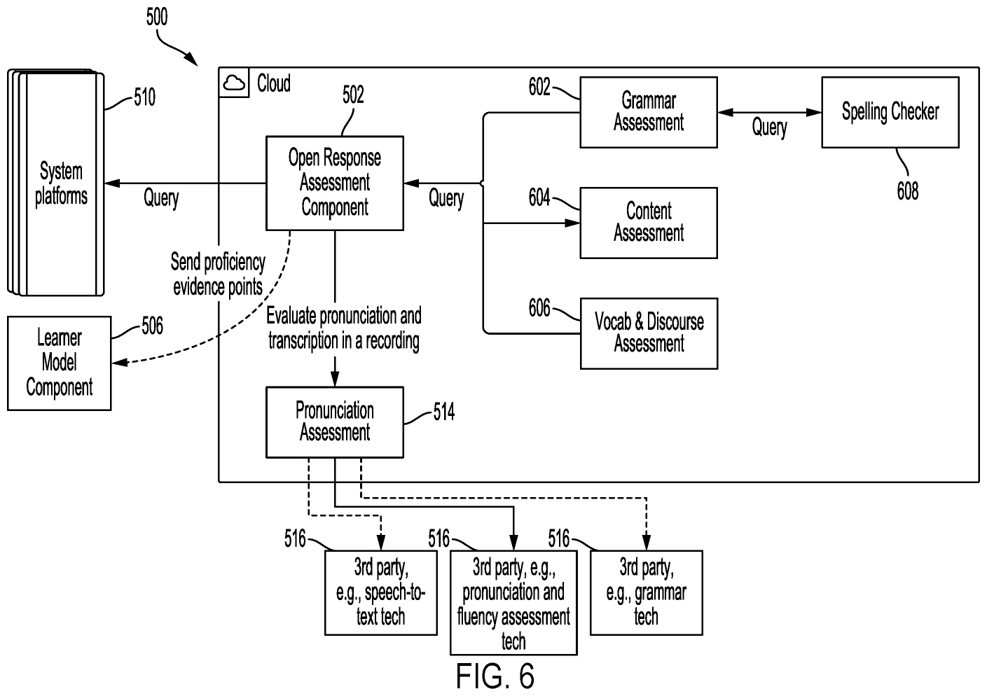

At block 404, the server 102 performs multiple open response assessments in real time in response to the one or more interactions. In some examples, to perform the multiple open response assessments in real time, the server 102 simultaneously performs the multiple open response assessments during the conversation. Referring to FIG. 6, the multiple open response assessments can include a grammar assessment 602, a content assessment 604, vocabulary and discourse assessment 606, and/or pronunciation assessment 514. In some examples, the server 102 can include different sets of open response assessments based on the type of response. For example, in response to the written response of an interaction of the open activity response, the server 102 can perform a first set of the plurality of open response assessments. In some scenarios, the first set can include at least one of: a grammar assessment 602, a content assessment 604, or a vocabulary and discourse assessment 606. In further examples, in response to the spoken response of an interaction of the open response assessments, the server 102 can perform a second set of the plurality of open response assessments. In some scenarios, the second set can include at least one of: the content assessment, the grammar assessment, the vocabulary and discourse assessment, or a pronunciation assessment. The first set of the multiple open response assessments can be the same as or be different from the second set of the multiple open response assessments. In some examples, the open response assessment can be considered “open” because the assessment is with respect to an open activity response, or because the open response assessment may be produced by utilizing various assessment tools to assess the response (e.g., system tools or third-party tools) and is not limited to a closed offering of assessment tools of the system operator.

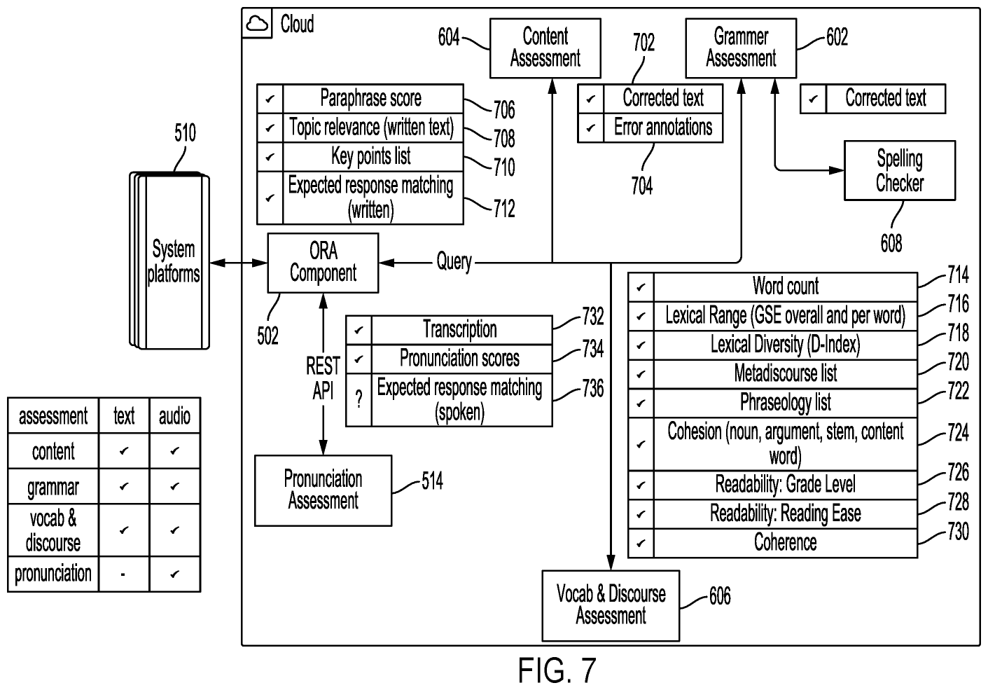

At block 406, the server 102 provides multiple assessment results corresponding to the multiple open response assessments. Each open response assessment provides a different assessment about the content, grammar, vocabulary, discourse, or pronunciation of the conversation to provide a different result as shown in FIG. 7. In some examples, the grammar assessment 602 is configured to assess grammar of an interaction of the open activity response and produce a first assessment result including at least one of: a corrected text 702 of the interaction, or an error annotation 704 of the interaction. In further examples, the grammar assessment 602 can further include a spelling checker 608 to identify and correct the text of the interaction with a spelling error. In further examples, the content assessment 604 is configured to assess content of the first interaction and produce a second assessment result including at least one of: a paraphrase score indication 706, a topic relevance score indication 708, a key-points list indication 710, or an expected response matching indication 712. In further examples, the vocabulary and discourse assessment 606 is configured to assess vocabulary and discourse of the interaction and produce a third assessment result including at least one of: a word count indication 714, a lexical range indication 716 (global scale of English overall and/or per word), a lexical diversity indication 178 (D-index), a meta-discourse list indication 720, a phraseology list indication 722, a cohesion indication 724 (e.g., noun, argument, stem, content word, etc.), a readability indication 726 (e.g., grade level, reading ease, etc.), or a coherence indication 730. In further examples, the pronunciation assessment 514 is configured to assess pronunciation of the interaction and produce a fourth assessment result including at least one of: a transcribed text 732 of the interaction, a pronunciation score indication 734, or a response matching score indication 736. In further examples, the pronunciation assessment 514 can be included in response to a spoken response of the open activity response. In further examples, the multiple assessment results can include at least one of the first. assessment result, the second assessment result, the third assessment result, or the fourth assessment result. In further examples, the open response assessment component 512 can further use third party components 516 (e.g., grammar tech, speech-to-text tech, SpeechAce, etc.) for the multiple open response assessments. In even further examples, the pronunciation assessment 514 can further use third party components 516 to produce or support the fourth assessment result. In some examples, the third-party components can include wrappers or interfaces, which can be directly used in the open response assessment component 502.

In further examples, the server 102 can provide the multiple assessment results from the open response assessment component 502 to the learner model component 506. The server 102 can collect the multiple assessment results at the learner model component 506 and determine a conversation difficulty level of the conversation based on multiple assessment results and/or other proficiency indications collected and aggregated at the learner model component. In some examples, the server 102 can provide a recommendation of the conversation difficulty level of the conversation to the user. In other examples, the server 102 can adjust the conversation difficulty level of the conversation to the user.

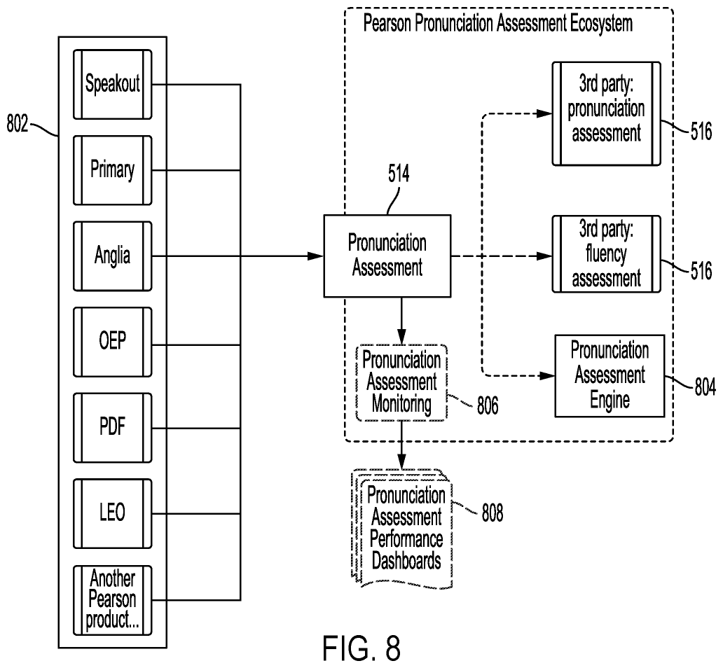

Referring to FIG. 8, the pronunciation assessment 514 can receive one or more audio responses from one or more tests or any other suitable interactive user activities 802 implemented by the system (e.g., the system 300 of FIG. 3). Then, the pronunciation assessment 514 can perform pronunciation assessment as described above to produce the fourth assessment result (e.g., using a pronunciation assessment engine 804 and/or third-party components 516). The server 102 can further perform pronunciation assessment result monitoring 806 and display the results on a performance dashboard 808.

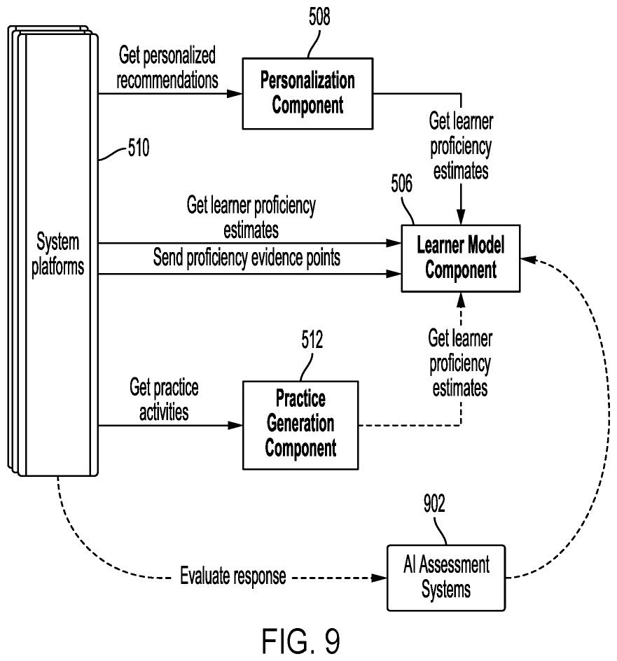

Referring to FIG. 9, the learner model component 506 can receive learner proficiency estimates and/or evidence points from various sources (e.g., platforms 510, personalization component 508, the practice generation component 512, an artificial intelligence assessment systems 902, and/or any other suitable sources). In some examples, the practice generation component 512 is a tool to generate and provide practice activities for various objectives, where the amount of practice activities may be large (almost infinite). Through the practice activities, the server 102 can assess learner's proficiency and provide the learner proficiency estimates to the learner model component 506. In further examples, the artificial intelligence assessment systems 902 can evaluate open activity response to provide learner proficiency estimate to the learner model component 506.

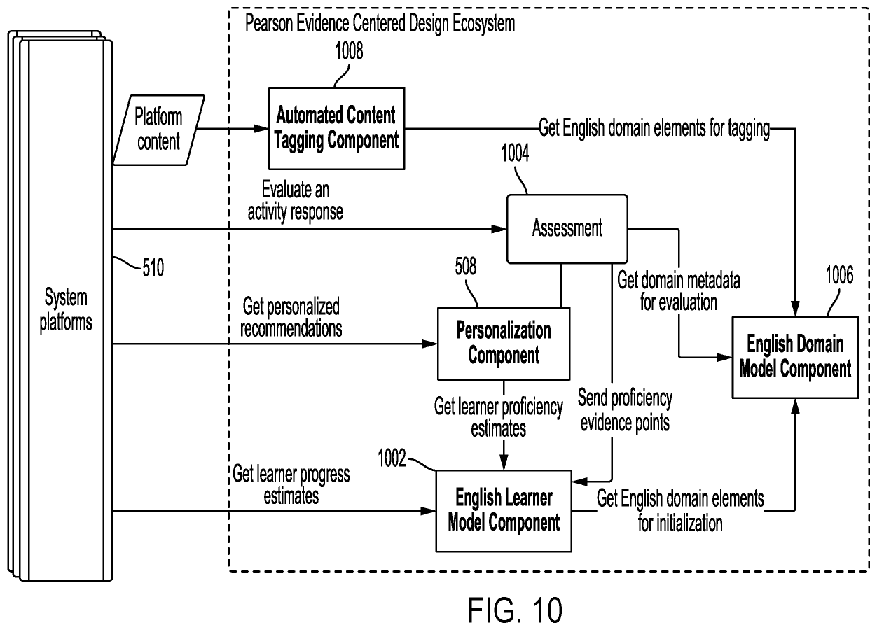

Referring to FIG. 10, an English learner model component 1002 can be similar to the learner model component 506 in FIG. 5. For example, the English learner model component 1002 may be a specific example of the learner model component 506 that is focused on English language learning. The English learner model component 1002 can receive learner progress estimates from the platforms 510, the personalization component 508 and/or an assessment 1004. The personalization component 508 can receive personalized recommendations from the platforms 510 and produce learner proficiency estimates to the English learner model component 1002. The assessment 1004 can evaluate an activity response and provide (English language) proficiency evidence points to the English learner model component 1002. Then, the English learner model component 1002 can provide English domain elements for initialization to an English domain model component 1006. The English domain model component 1006 can also receive domain metadata for evaluation from the assessment 1004 and English domain elements for tagging from an automated content tagging component 1008.

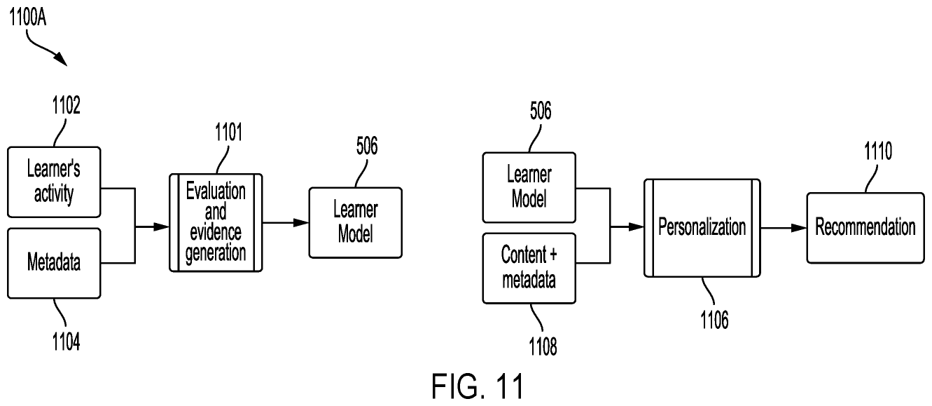

Referring to FIG. 11, the server 102 can evaluate and provide an assessment result via evaluation block 1101 to the learner model 506 based on the learner's activity 1102 and metadata 1104. The evaluation block 1101 may be implemented by, for example, the open response assessment component 502. In further examples, the server 102 can produce personalized data 1106 based on the learner model 506 and content with metadata 1108 and produce a personalized recommendation 1110 to the learner.

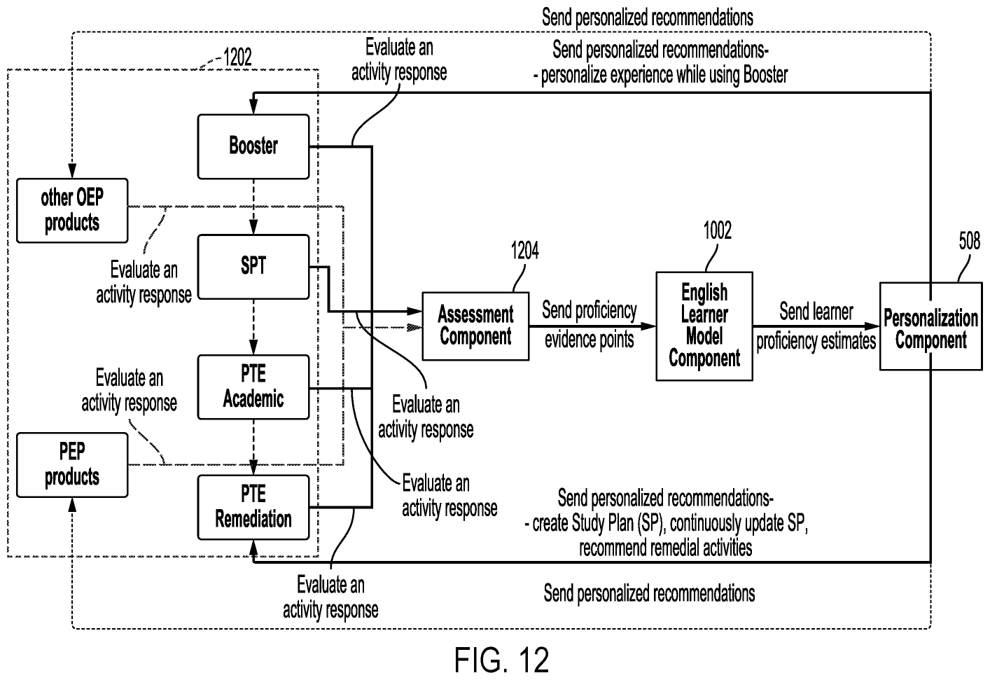

Referring to FIG. 12, the server 102 can monitor system-implemented tests and learner's activities 1202 and assess activity responses of tests and learner's activities 1202 in the assessment component 1204. The server 102 can send the assessment result or proficiency evidence points to the English learner model component 1002 based on the activity responses. The English learner model component 1002 can generate and send learner proficiency estimates to the personalization component 508 based on the assessment results or proficiency evidence points. The server 102 can send personalized recommendations (e.g., personalized experience, study plan, remedial activities, etc.) to the user (e.g., as assessments and results rendering 318 via the GUI 316 of FIG. 3).

FIG. 13 is a flowchart illustrating another example method and technique for a real-time open activity response assessment system, in accordance with various aspects of the techniques described in this disclosure. The flowchart of FIG. 13 utilizes various system components that are described herein with reference to FIGS. 1-12 and/or 14-19B. In some examples, the process 1300 may be carried out by the server(s) 102 illustrated in FIG. 3, e.g., employing circuitry and/or software configured according to the block diagram illustrated in FIG. 2. In some examples, the process 1300 may be carried out by any suitable apparatus or means for carrying out the functions or algorithm described below. Additionally, although the blocks of the flowchart 1300 are presented in a sequential manner, in some examples, one or more of the blocks may be performed in a different order than presented, in parallel with another block, or bypassed.

At block 1302, a server (e.g., one or more of the server(s) 102, also referred to as the server 102) receives an open activity response from a client device 106 of a user. In some examples, the open activity response includes a written response. In further examples, the open activity response can further include a spoken response where the written response is a transcribed response of the spoken response. In some examples, the spoken response or the written response can include one or more sentences. In other examples, the spoken response or the written response can include one or more words or characters. In some examples, an open activity response can be one interaction with the server 102. The one interaction can include one or more sentences or words. However, in other examples, the open activity response can be multiple interactions with the server 102. In some scenarios, the open activity response can be produced in various sources. In some examples, the open activity response can be produced during a conversation between an agent and the user. In further scenarios, the agent can include a conversational computing agent comprising a program designed to process the conversation with the user. In other scenarios, the agent can be a human agent. In further examples, the open activity response can be produced during a test, an examination, an online learning class, an online learning game, a post, a written or written question/answer, or any other suitable source.

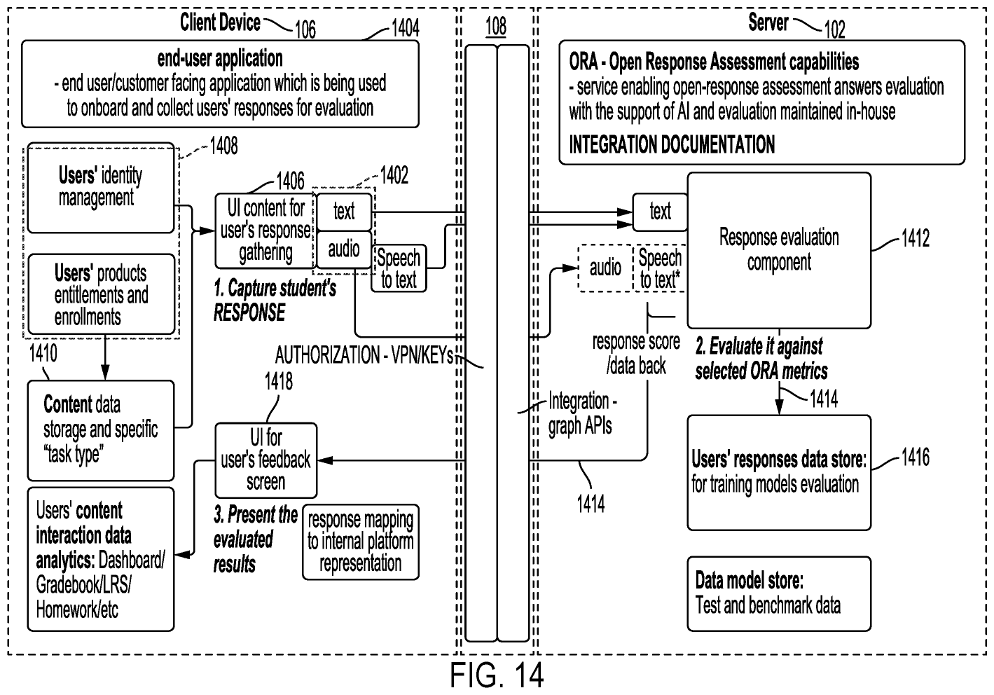

FIG. 14 is a block diagram to show interactions between the client device 106 and the server 102 and processes in the client device 106 and/or the server 102. In some examples, the client device 106 can capture an open activity response 1402 through an end-user application 1404 and transmit the open activity response 1402 to the server 102 (e.g., to be received, as an example of block 1302). In some examples, the end-user application 1404 can be stored in the memory of the client device 106 to produce content 1406, also referred to as UI content 1406, on a GUI or a speaker 320 of the client device 106. In other examples, the end-user application 1404 can be stored in the server 102 and transmit the content 1406 to be displayed on a GUI or a speaker of the client device 106. In further examples, the end-user application 1404 can be a third-party application and transmit the open activity response 1402. In some examples, the content 1406 in the end-user application can include a question or request for a predetermined topic or objective with one or more expected answers or words. In further examples, the content 1406 in the end-user application can be determined by user information 1408 and/or a task type 1410. In some examples, the user information 1408 can include any suitable information to determine the difficulty, topic, and/or objective of the content. For example, the user information 1408 can include an age, past assessment results, topics selected or to be improved, user's products/entitlements/enrollments information, or any other suitable user information. In some examples, the task type 1410 can include a topic (e.g., camping, traveling, eating-out, etc.), a type of content (e.g., a speaking, listening, reading, and/or writing question of the content, etc.) or any other suitable task. However, it should be appreciated the content 1406 for an open activity response 1402 of the user is not limited to a predetermined content. For example, the content 1406 can be a chat box with an agent (e.g., a conversational computing agent or a human agent). Thus, the open activity response is considered “open” because the source or end-user application to provide the open activity response can be various and flexible and/or the open activity response can include time-series data without a fixed time period or any fixed format.

In some examples, in response to the content 1406, the user can provide, via the client device 106, the open activity response 1402 to the server 102, and the server 102 can receive the open activity response 1402 from the client device 106 of the user. In some examples, the open activity response 1402 can be received through the security and integration components 108. In some examples, the open activity response 1402 can include a spoken response, which is audio data. In some examples, the client device 106 can convert the audio data into a written response, which is text data, and transmit the written response and/or the spoken response to the server 102. In other examples, the server 102 can receive the spoken response and convert the spoken response into the written response and process the written response and/or spoken response. In further examples, the open activity response 1402 can include a written response, which is text data, and can be transmitted to the server 102.

Referring again to FIG. 13, at block 1304, the server 102 provides the open activity response to multiple machine learning models to process multiple open response assessments in real time in response to the open activity response. The multiple machine learning models can correspond to the multiple open response assessments. In some examples, a first open response assessment of the multiple open response assessments is agnostic with respect to a second open response assessment of the multiple open response assessments. The first open response assessment being agnostic with respect to the second open response assessment can indicate that the first open response assessment is independent from or is not being affected by the second open response assessment. Thus, although the first open response assessment and the second response assessment are processed based on the same open activity response, the first open response assessment and the second response assessment are independently processed to provide a first assessment score and a second assessment score, respectively. In some examples, the open response assessment(s) can be product-agnostic with the high degree of freedom in API request definition. Thus, a user, via the client device 106, can request for vocabulary assessment only, without requesting assessments for other domains or programs.

In some examples, in block 1304, the server 102 may select one or more of the multiple machine learning models from a plurality of available machine learning models. For example, the server 102 may select one or more machine learning models with desirable characteristics for a particular scenario. For example, the server 102 may identify the one or more machine learning models to use based on the open activity response, a user input, or any suitable indication. In some examples, the server 102 can further use a lookup table to identify the machine learning models to use for each type of assessment. For example, the server 102 may access the lookup table with the type of assessment to be performed and/or information about the particular scenario or open activity response, and the lookup table may provide an identifier for the particular machine learning model to use for the assessment. Thus, using the lookup table, the server 102 can identify and select each machine learning model to use for the assessments. In some examples, the server 102 can use an API to interface with the selected machine learning models to use for each type of assessment. The identifier from the lookup table may indicate the API to use for each selected machine learning model. Machine learning models for a particular assessment may be modular and interchangeable. Thus, the available machine learning models for selection by the server 102 may be updated or replaced over time. Then, at run-time, the server 102 may select from the currently available machine learning models, for example, by accessing the lookup table or other mapping function. Thus, the particular combination of machine learning models used to assess an open activity response may be selected and may evolve over time to address changing needs and capabilities of the system and available assessment models

Referring again to FIG. 14, the server 102 can receive the open activity response 1402 from the client device 106 and provide the open activity response 1402 to the response evaluation component 1412 (e.g., an example of the open response assessment component 502 of FIG. 5), which includes multiple machine learning models. In some examples, the machine learning models can be stored in the computer readable storage media 216 or the system memory 218 of the server 102. In other examples, one or more machine learning models can be stored in a database or other memory of an external system (e.g., a third-party system) to process one or more corresponding open response assessments. In such examples, the server 102 can transmit the open activity response 1402 to the external system.

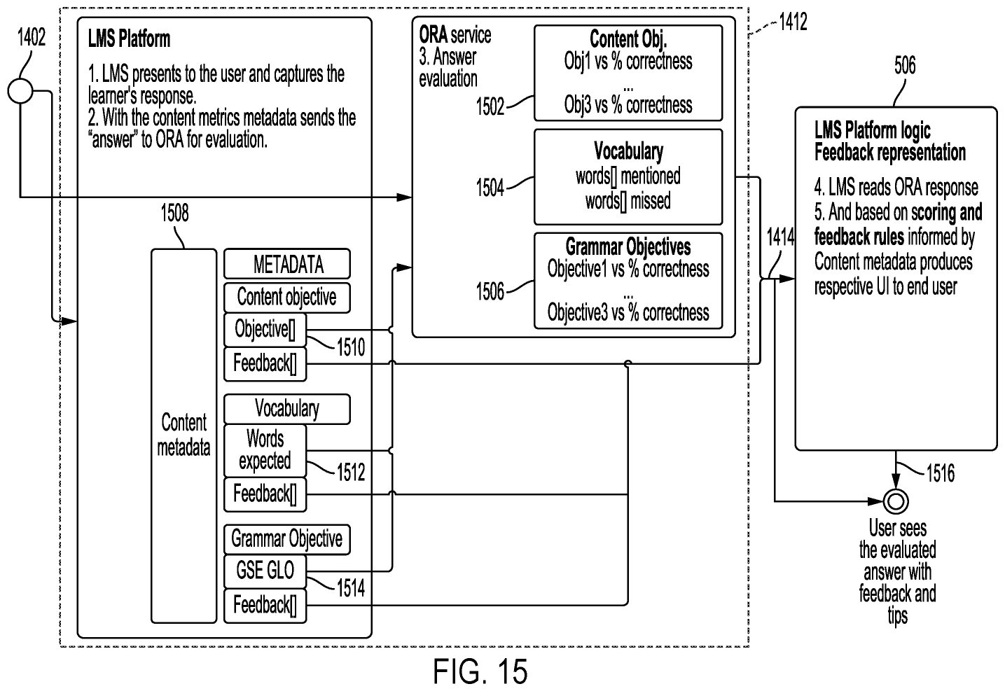

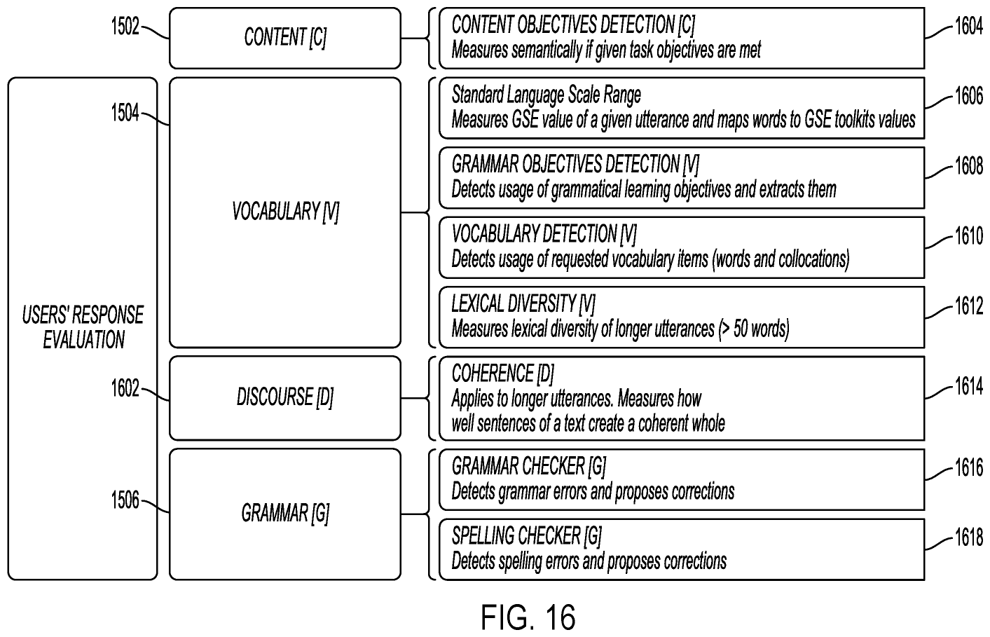

FIG. 15 is a block diagram to show an example of the response evaluation component 1412 of FIG. 14. In some examples, the multiple open response assessments can include at least one of: a content assessment 1502, a vocabulary assessment 1504, a discourse assessment, a grammar assessment 1506, or a speaking assessment (not shown). FIG. 16 is a block diagram to show assessment metrics of multiple open response assessments.

In some examples, the content assessment 1502 can be processed based on a first machine learning model of the multiple machine learning models. In some examples, the content assessment 1502 indicates input evaluation supported by natural language processing against its context and expected content goals/objectives to detect one or more content objectives. The content assessment 1502 can perform content objectives detection 1604 to measure semantically if one or more content objectives are met. For example, the first machine learning model can include a neural network-based language model (e.g., Dilstilbart). In some examples, the first machine learning model can be fine-tuned for natural language inference. In addition, the server 102 can determine one or more objectives to be compared with the open activity response. In further examples, the server 102 can process multiple-objective evaluation for the content assessments 1502. For example, an objective is “this text mentions someone's future plans.” Then, the server 102 can provide the open activity response to the first machine learning model to process the content assessment 1502 and receive a decimal value (e.g., 0.942636489868141) to indicate how close the open activity response is to the objective.

In some examples, the vocabulary assessment 1504 can be processed based on a second machine learning model of the multiple machine learning models. For example, the second machine learning model can include a classifier model or any other suitable model. In some examples, the vocabulary assessment 1504 can indicate input evaluation against the vocabulary used (e.g., the input word's correctness against language use). In some examples, the vocabulary assessment 1504 can evaluate user's input against complexity/diversity or words mapping against the language scale values (e.g., Global Scale of English (GSE) toolkit values). In some examples, the vocabulary assessment 1504 can include a standard language scale range assessment 1606, a grammar objectives detection assessment 1608, a vocabulary detection assessment 1610, and/or a lexical diversity assessment 1612 using one or more second machine learning models.

In some examples, the vocabulary assessment 1504 can include the standard language scale range assessment 1606 to measure a language scale value (e.g., a GSE value) of a given utterance and maps words to standard values (e.g., GSE toolkit values). In some examples, the vocabulary assessment 1504 can perform mapping between the open activity response and standard language scale vocabulary (e.g., GSE vocabulary). The mapping can include individual words mapping and the whole sentence evaluation and mapping to the standard language scale (e.g., GSE). For example, the open activity response can be “I love hiking with my friends and family. We enjoy spending time together.” Then, the vocabulary assessment 1504 can map “love” to GSE value 19, “hiking” to GSE value 68, “family” to GSE value 15, “spending” to GSE value 28, “time” to GSE value 18, and “together” to GSE value 34, and produce overall GSE value 33.7. The values and the type of standard language scale are not limited to the examples above.

In further examples, the vocabulary assessment 1504 can include the grammar objectives detection assessment 1608 to detect usage of grammatical learning objectives and extracts the objectives from the open activity response. In some examples, the vocabulary assessment 1504 can map the open activity response to grammar phrases in a standard language scale data (e.g., GSE toolkit syllabus).

In further examples, the vocabulary assessment 1504 can include the vocabulary detection assessment 1610 to detect usage of desirable vocabulary items (words and collocations). In some examples, the vocabulary assessment 1504 can split the open activity response into individual words and compare the individual words to given words. For example, when the open activity response is “I love hiking with my friends” and the given words include “friends,” the vocabulary assessment 1504 can produce an indication that “friends” is included in the given words while “hiking” is not included. In some examples, the second machine learning model to process the vocabulary assessment 1504 for the vocabulary detection 1610 can include a classifier (e.g., a language model).

In further examples, the vocabulary assessment 1504 can include the lexical diversity assessment 1612 to measure lexical diversity of longer utterances (e.g., more than 50 words). In some examples, the vocabulary assessment 1504 can produce a lexical diversity score based on an index (e.g., the measure of textual lexical diversity (MTLD), vocd-D (or HD-D), and/or Maas) and list of most repeated words with the corresponding counts except for stop words.

In some examples, the discourse assessment 1602 can be processed based on a third machine learning model of the multiple machine learning models. In some examples, the discourse assessment 1602 can include a coherence assessment 1614 to measure how well sentences of the open activity response create a coherent whole. For example, the third machine learning model can include a transformer model (e.g., BERT model).

In some examples, the grammar assessment 1506 can be processed based on a fourth machine learning model of the multiple machine learning models. In some examples, the grammar assessment 1506 can allow for grammar correction evaluation against spelling mistakes or incorrect grammar forms being used in the open activity response. In further examples, the server 102 can suggest a correct from for the spelling and/or grammar mistakes. In some examples, the fourth machine learning model can include a dependency matcher model. For examples, the fourth machine learning model for the grammar assessment 1506 can include Dependency Matcher. grammar learning objectives (e.g., GSE grammar learning objectives) can be converted to patterns of the Dependency Matcher that later can be used to detect those learning objectives.

In further examples, the multiple open response assessments can further include a speaking assessment configured to be processed based on a fifth machine learning model of the multiple machine learning models. In some examples, the speaking assessment can include a speech to text feature to convert the audio of the open activity response to a written response (e.g., text). In further examples, the speaking assessment can include a pronunciation assessment feature to assess pronunciation of the audio of the open activity response. In further examples, the speaking assessment can include a fluency assessment feature to assess the fluency of the audio of the open activity response.

In some examples, as part of block 1304 (FIG. 13), and referring again to FIG. 15, the server 102 can provide multiple metadata 1508 of the open activity response 1402 to the multiple machine learning models. The machine learning models (e.g., of the content assessment 1502, vocabulary assessment 1504, and/or grammar assessment 1506) may process the open activity response 1402 with the metadata 1508 to perform the respective assessments. The multiple metadata 1508 can correspond to the multiple machine learning models. In some examples, a first metadata of the multiple metadata for the first machine learning model can include a content objective 1510. In some examples, a second metadata of the multiple metadata for the second machine learning model can include the list of predetermined words 1512. In some examples, a third metadata of the multiple metadata for the third machine learning model can include an expected sentence. In some examples, a fourth metadata of the multiple metadata for the fourth machine learning model can include a grammar learning objective 1514. In some examples, the multiple metadata 1508 can be standards or references to be compared with the open activity response in multiple machine learning models, respectively. In some examples, the metadata can be generated in the learner model component 506 in FIG. 5 or any other suitable component. In some examples, the metadata can be generated in the client device 106 or the server 102 associated with the end-user application 1404 of FIG. 14, an online class, any post, or any suitable response.

Referring again to FIG. 13, at block 1306, the server 102 receives multiple assessment scores from the multiple machine learning models, the multiple assessment scores corresponding to the multiple open response assessments. For example, each machine learning model of the response evaluation component 1412 may generate a respective assessment score corresponding to the open activity response 1402 (or corresponding to the open activity response 1402 and associated metadata of the metadata 1508). In some examples, the server 102 receives an assessment score from a machine learning model, which is stored in the memory of the server 102. In other examples, the server 102 receives an assessment score from a machine learning model via the communication network 120. In some examples, a machine learning model is in an external system, and the server 102 can receive one or more assessment scores from the external system via the communication network 120. In some examples, the multiple assessment scores can include raw data (e.g., a confidence score value) or any other suitable indication. Referring again to FIG. 14, in some examples, the response evaluation component 1412 can provide an output 1414 to the client device 106 and/or a data storage 1416. The output 1414 to the data storage 1416 can be used for training or tuning the multiple machine learning models. In some examples, the output 1414 of the response evaluation component 1412 can include the multiple assessment scores. Referring again to FIG. 15, in some examples, the output of the response evaluation component 1412 can include the multiple assessment scores. In some examples, the server can provide the multiple assessment scores to the learner model component 506 of FIG. 5.

In some examples, a first assessment score is received from a first machine learning model of the multiple machine learning models. In some examples, the first assessment score can indicate a first confidence score about how close the open activity response is to a content objective. In some examples, the first assessment score can be a decimal value or any suitable indication. In some examples, a second assessment score is received from a second machine learning model of the multiple machine learning models. In some examples, the second assessment score can indicate a second confidence score about how many words in the open activity response are close to a list of predetermined words. In some examples, a third assessment score is received from a third machine learning model of the multiple machine learning models. In some examples, the third assessment score can indicate a third confidence score about how close a following sentence subsequent to a previous sentence in the open activity response is close to an expected sentence. In some examples, a fourth assessment score is received from a fourth machine learning model of the multiple machine learning models. In some examples, the fourth assessment score can indicate a fourth confidence score about how a grammar structure of the open activity response is close to a grammar learning objective. In some examples, a fifth assessment score is received from a fifth machine learning model of the multiple machine learning models. In some examples, the fifth assessment score can indicate a fifth confidence score about how a pronunciation and fluency of the open activity response is close to a speaking objective.

Referring again to FIG. 13, at block 1308, the server 102 provides multiple assessment results to the client device 106 of the user based on the multiple assessment scores corresponding to the multiple open response assessments associated with the open activity response. Referring again to FIG. 15, in some examples, the multiple assessment scores can be raw data, and the server 102 can generate multiple assessment results, which are intuitive and understandable to the user, based on the multiple assessment scores. In some examples, the server 102 can provide the output 1414 (e.g., the multiple assessment scores) of the response evaluation component 1412 to the learner model component 506 to generate multiple assessment results. In some examples, the output 1516 of the learner model component 506 can include the assessment results. In some examples, the assessment results can include user-oriented information (e.g., fluency percentage, fluency level, any other suitable information converted from the assessment score) and/or corresponding metadata (e.g., content object, expected or predetermined words, grammar objectives, etc.) In other examples, the output 1414 of the response evaluation component 1412 can be transmitted to the client device 106 to generate the assessment results in the client device 106. Referring again to FIG. 14, in some examples, the output 1414 of the response evaluation component can be the multiple assessment scores or the multiple assessment results. When the output 1414 of the response evaluation component includes the multiple assessment scores, the client device 106 generates the assessment results based on the assessment scores and provides the assessment results as UI output content 1418 on the graphical user interface 316 or speaker 320 of the client device 106.

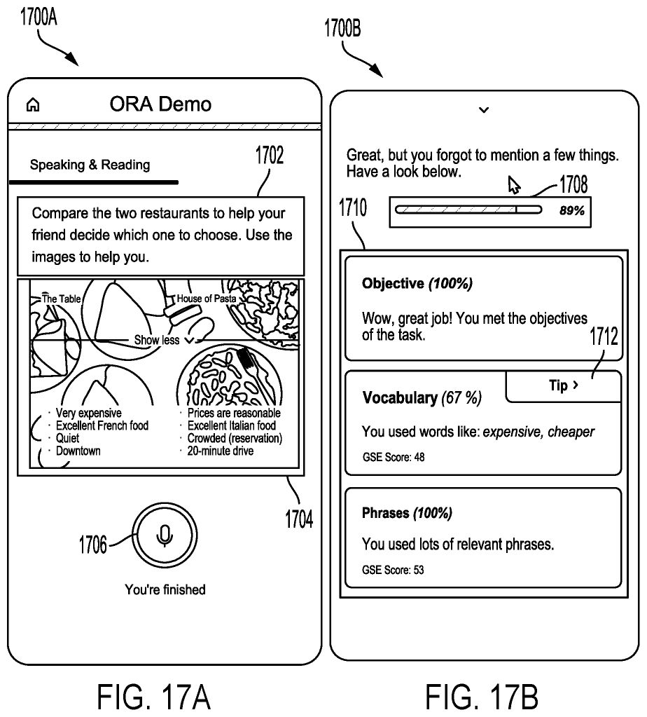

Referring to FIG. 17A, the server 102 can generate a speaking & reading assessment screen 1700A on the client device 106. For example, the screen 1700A may serve as the UI content 1406 (see FIG. 14) on the graphic user interface 316 of the client device 106 (see FIG. 13). For example, the server 102 can show instructions 1702 (e.g., “Compare the two restaurants to help your friend decide which one to choose. Use the image to help you” or any other suitable instructions) and/or images 1704 (e.g., of menus, food, balls, any other suitable items or environments to practice speaking) on the screen 1700A. Then, the server 102 can receive a user input 1706 for recording what the learner speaks and generating corresponding audio data in response to the instructions 1702. In some examples, the server 102 can receive a first user input 1706 to start recording and a second user input 1706 to stop recording. The server 102 can store the audio data in the database 110 and transcribe the audio data to a written response and/or evaluate pronunciation of the learner. The server 102 can further provide the transcribed written response into the response evaluation component 1412 and multiple machine learning models in the response evaluation component to process at least one of the content assessment 1502, the vocabulary assessment 1504, the discourse assessment, or the grammar assessment 1506 for the written response. In further examples, the server 102 can further process the speaking assessment for the audio data.

Referring to FIG. 17B, the server 102 can generate an assessment result screen 1700B on a graphic user interface 1418 of FIG. 14 of the client device 106 to show the assessment results based on assessment scores of the multiple machine learning models. For example, the server 102 can provide an overall assessment result 1708. In some examples, the server 102 can calculate the overall assessment result 1708 by calculating an average or a weighted average of all assessment results. In further examples, the overall assessment result 1708 can be shown as a percentage, a number, or any other suitable indication. The server 102 can also provide each assessment result 1710 from the one or more open response assessments. In further examples, the server 102 can provide feedback and suggestions to improve speaking based on the assessment results 1710 and/or metadata corresponding to the open response assessments. For example, the server 102 can receive another user input 1312 to select a tip of a corresponding assessment. Then, the server 102 can show analysis of the audio data (e.g., how to calculate the assessment result, how and what the learner spoke) and suggestions (e.g., synonyms, different phrases, etc.). It should be appreciated that the instructions can be provided in any suitable forms (e.g., spoken instructions or written instructions) and the answers can be provided to the server 102 in any suitable forms (e.g., spoken answer or written answer).

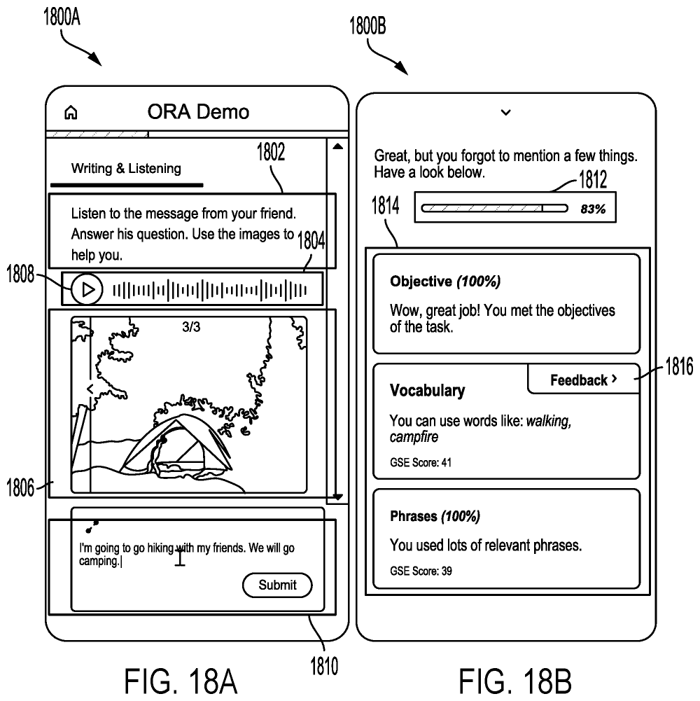

Referring to FIG. 18A, the server 102 can generate a writing & listening assessment screen 1800A on the client device 106. For example, the screen 1800A may serve as the UI content 1406 (see FIG. 14) on the graphic user interface 316 of the client device 106 (see FIG. 13). For example, the server 102 can shows instructions 1802 (e.g., “Listen to the message from your friend. Answer his question. Use the images to help you” or any other suitable instructions), an audio indication 1804 to listen to the message, and/or images 1806 (e.g., of menus, food, balls, any other suitable items or environments to practice writing) on the screen 1800A. Then, the server 102 can receive a first user input 1808 for listening the message. In response to the first user input 1808, the server 102 can play audio data (e.g., about the message from the friend). In some examples, the server 102 can receive a second user input 1810 to answer to the message. The second user input 1810 can be a written answer provided by the keyboard, audio data recorded by the microphone, or any other suitable input. The server 102 can provide user input 1810 (e.g., written answer) from the audio data into the response evaluation component 1412 of FIG. 14 and assess the grammar (e.g., processing the grammar assessment 1506 using the corresponding machine learning model(s)), the content (processing the content assessment 1502 using the corresponding machine learning model), and/or vocabulary and discourse (using the vocabulary and discourse assessment(s) 1504 using the corresponding machine learning models) to provide assessment results from one or more open response assessments.

Referring to FIG. 18B, the server 102 can generate an assessment result screen 1800B on a graphic user interface 1418 of FIG. 14 of the client device 106 based on the assessment results from one or more open response assessment components (e.g., the grammar assessment 1506, the content assessment 1502, the vocabulary and discourse assessment 1504, and/or any other suitable assessment). For example, the server 102 can provide an overall assessment result 1812. In some examples, the server 102 can calculate the overall assessment result 1812 by calculating an average or a weighted average of all assessment results. In further examples, the overall assessment result 1812 can be shown as a percentage, a number, or any other suitable indication. The server 102 can also provide each assessment result 1814 from the one or more assessment components. In further examples, the server 102 can provide feedback and suggestions to improve speaking. For example, the server 102 can receive another user input 1816 to select a tip of a corresponding assessment. Then, the server 102 can show analysis of the audio data (e.g., how to calculate the assessment result, how and what the learner wrote) and suggestions (e.g., synonyms, different phrases, etc.).

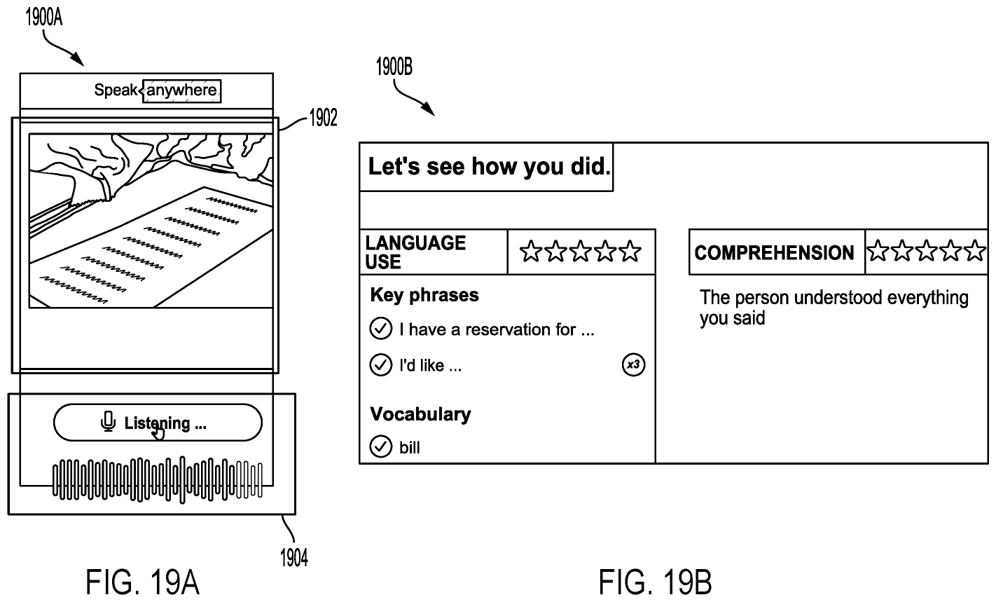

Referring to FIG. 19A, the server 102 can generate a speaking and listening assessment screen 1900A on the client device 106. For example, the screen 1900A may serve as the UI content 1406 (see FIG. 14) on the graphic user interface 316 of the client device 106 (see FIG. 13). For example, the server 102 can show an image or written statement(s) 1902 and provide a spoken message. Then, the server 102 can receive a user input 1904 to respond to the spoken message. The user input 1904 can be audio data recorded by the microphone, or any other suitable input. The server 102 can store the audio data in the database 110 and provide the audio data to the speaking assessment to transcribe the audio data and/or evaluate pronunciation and/or fluency of the user. The server 102 can further provide transcribed data from the audio data into the response evaluation component 1412 and assess the grammar (e.g., using the grammar assessment 1506), the content (using the content assessment 1502), and/or vocabulary and discourse (using the vocabulary and discourse assessment 1504) to provide assessment results from one or more open response assessments.

Referring to FIG. 19B, the server 102 can generate an assessment result screen 1900B on a graphic user interface 1418 of FIG. 14 based on the assessment results from one or more open response assessments (e.g., the speaking assessment, the grammar assessment 1506, the content assessment 1502, the vocabulary and discourse assessment 1504, and/or any other suitable assessment).

In an example, the systems and methods described herein (e.g., the real-time activity response assessment system 300, the method 400, etc.) enable an efficient technique for assessing a conversation or a response in real-time such that the system receives an open activity response, perform multiple open response assessments in real time in response to the open activity response, and provide multiple assessment results corresponding to the plurality of open response assessments. Such conversation or response assessment in real-time improves learner's learning ability due to spontaneous feedback. Further, such conversation or response assessment enriches materials for the assessment and enable accurate assessment of the users.

Other examples and uses of the disclosed technology will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

What is claimed is:

1. A method for dynamic open activity response assessment, the method comprising:
receiving, by an electronic processor via a network, an open activity response from a client device of a user;
in response to the open activity response, providing, by the electronic processor, the open activity response to a plurality of machine learning models to process a plurality of open response assessments in real time, the plurality of machine learning models corresponding to the plurality of open response assessments, a first open response assessment of the plurality of open response assessments being agnostic with respect to a second open response assessment of the plurality of open response assessments;
receiving, by the electronic processor, a plurality of assessment scores from the plurality of machine learning models, the plurality of assessment scores corresponding to the plurality of open response assessments; and
providing, by the electronic processor, a plurality of assessment results to the client device of the user based on the plurality of assessment scores corresponding to the plurality of open response assessments associated with the open activity response.

2. The method of claim 1, wherein the open activity response comprises a written response.

3. The method of claim 2, wherein the plurality of open response assessments comprises at least one of: a content assessment, a vocabulary assessment, a discourse assessment, a grammar assessment, or a speaking assessment.

4. The method of claim 3, wherein the content assessment is configured to be processed based on a first machine learning model of the plurality of machine learning models,
wherein the vocabulary assessment is configured to be processed based on a second machine learning model of the plurality of machine learning models,
wherein the discourse assessment is configured to be processed based on a third machine learning model of the plurality of machine learning models, and
wherein the grammar assessment is configured to be processed based on a fourth machine learning model of the plurality of machine learning models.

5. The method of claim 4, wherein the first machine learning model comprises a neural network-based language model,
wherein the second learning model comprises a classifier model,
wherein the third learning model comprises a transformer model, and
wherein the fourth machine learning model comprises a dependency matcher model.

6. The method of claim 5, wherein a first assessment score is received from a first machine learning model of the plurality of machine learning models, the first assessment score being indicative of a first confidence score about how close the open activity response is to a content objective,
wherein a second assessment score is received from a second machine learning model of the plurality of machine learning models, the second assessment score being indicative of a second confidence score about how many words in the open activity response are close to a list of predetermined words,
wherein a third assessment score is received from a third machine learning model of the plurality of machine learning models, the third assessment score being indicative of a third confidence score about how close a following sentence subsequent to a previous sentence in the open activity response is close to a predicted sentence, and
wherein a fourth assessment score is received from a fourth machine learning model of the plurality of machine learning models, the fourth assessment score being indicative of a fourth confidence score about how a grammar structure of the open activity response is close to a grammar learning objective.

7. The method of claim 6, further comprising:
in response to the open activity response, providing a plurality of metadata of the open activity response to the plurality of machine learning models, the plurality of metadata corresponding to the plurality of machine learning models,
wherein a first metadata of the plurality of metadata for the first machine learning model comprises the content objective,
wherein a second metadata of the plurality of metadata for the second machine learning model comprises the list of the predetermined words,
wherein a third metadata of the plurality of metadata for the third machine learning model comprises the predicted sentence, and
wherein a fourth metadata of the plurality of metadata for the fourth machine learning model comprises the grammar learning objective.

8. The method of claim 2, wherein the open activity response further comprises a spoken response, and
wherein the written response is a transcribed response of the spoken response.

9. The method of claim 8, wherein the plurality of open response assessments further comprises a speaking assessment configured to be processed based on a fifth machine learning model of the plurality of machine learning models.

10. The method of claim 9, wherein a fifth assessment score is received from a fifth machine learning model of the plurality of machine learning models, the fifth assessment score being indicative of a fifth confidence score about how a pronunciation and fluency of the open activity response is close to a speaking objective.

11. The method of claim 1, wherein the open activity response is produced during a conversation between an agent and the user.

12. The method of claim 11, wherein the agent comprises a conversational computing agent comprising a program designed to process the conversation with the user.

13. A system for dynamic open activity response assessment, comprising:
a memory; and
an electronic processor coupled with the memory,
wherein the processor is configured to:
receive an open activity response from a client device of a user;
in response to the open activity response, provide the open activity response to a plurality of machine learning models to process a plurality of open response assessments in real time, the plurality of machine learning models corresponding to the plurality of open response assessments, a first open response assessment of the plurality of open response assessments being agnostic with respect to a second open response assessment of the plurality of open response assessments;
receive a plurality of assessment scores from the plurality of machine learning models, the plurality of assessment scores corresponding to the plurality of open response assessments; and
provide a plurality of assessment results to the client device of the user based on the plurality of assessment scores corresponding to the plurality of open response assessments associated with the open activity response.

14. The system of claim 13, wherein the open activity response comprises a written response.

15. The system of claim 14, wherein the plurality of open response assessments comprises at least one of: a content assessment, a vocabulary assessment, a discourse assessment, or a grammar assessment.

16. The system of claim 15, wherein the content assessment is configured to be processed based on a first machine learning model of the plurality of machine learning models,
wherein the vocabulary assessment is configured to be processed based on a second machine learning model of the plurality of machine learning models,
wherein the discourse assessment is configured to be processed based on a third machine learning model of the plurality of machine learning models, and
wherein the grammar assessment is configured to be processed based on a fourth machine learning model of the plurality of machine learning models.

17. The system of claim 16, wherein the first machine learning model comprises a neural network-based language model,
wherein the second learning model comprises a classifier model,
wherein the third learning model comprises a transformer model, and
wherein the fourth machine learning model comprises a dependency matcher model.

18. The system of claim 17, wherein a first assessment score is received from a first machine learning model of the plurality of machine learning models, the first assessment score being indicative of a first confidence score about how close the open activity response is to a content objective,
wherein a second assessment score is received from a second machine learning model of the plurality of machine learning models, the second assessment score being indicative of a second confidence score about how many words in the open activity response are close to a list of predetermined words,
wherein a third assessment score is received from a third machine learning model of the plurality of machine learning models, the third assessment score being indicative of a third confidence score about how close a following sentence subsequent to a previous sentence in the open activity response is close to a predicted sentence, and
wherein a fourth assessment score is received from a fourth machine learning model of the plurality of machine learning models, the fourth assessment score being indicative of a fourth confidence score about how a grammar structure of the open activity response is close to a grammar learning objective.

19. The system of claim 18, wherein the processor is further configured to
in response to the open activity response, provide a plurality of metadata of the open activity response to the plurality of machine learning models, the plurality of metadata corresponding to the plurality of machine learning models,
wherein a first metadata of the plurality of metadata for the first machine learning model comprises the content objective,
wherein a second metadata of the plurality of metadata for the second machine learning model comprises the list of the predetermined words,
wherein a third metadata of the plurality of metadata for the third machine learning model comprises the predicted sentence, and
wherein a fourth metadata of the plurality of metadata for the fourth machine learning model comprises the grammar learning objective.

20. The system of claim 14, wherein the open activity response further comprises a spoken response, and
wherein the written response is a transcribed response of the spoken response.

21. The system of claim 20, wherein the plurality of open response assessments further comprises a speaking assessment configured to be processed based on a fifth machine learning model of the plurality of machine learning models.

22. The system of claim 21, wherein a fifth assessment score is received from a fifth machine learning model of the plurality of machine learning models, the fifth assessment score being indicative of a fifth confidence score about how a pronunciation and fluency of the open activity response is close to a speaking objective.

23. The system of claim 13, wherein the open activity response is produced during a conversation between an agent and the user.

24. The method of claim 23, wherein the agent comprises a conversational computing agent comprising a program designed to process the conversation with the user.
